(19) United States
(12) Patent Application Publication
(10) Pub. No.: US 2024/0114073 A1
(43) Pub. Date: Apr. 4, 2024

(54) PROVIDING REMOTE ACCESS AND PACKET RETRANSMISSION VIA THIRD PARTY NETWORKS

(71) Applicant: Citrix Systems, Inc., Fort Lauderdale, FL (US)

(72) Inventors: Daniel Wing, Truckee, CA (US); Sridharan Rajagopalan, Pompano Beach, FL (US); Rakesh Jha, San Jose, FL (US)

(73) Assignee: Citrix Systems, Inc., Fort Lauderdale, FL (US)

(21) Appl. No.: 17/956,263

(22) Filed: Sep. 29, 2022

(51) Int. Cl. H04L 67/141; H04L 67/146; H04L 69/321

(52) U.S. Cl. CPC H04L 67/141; H04L 67/146; H04L 69/321

(57) ABSTRACT

The present solution provides systems and methods for providing remote access and packet retransmission via third party networks. A device can receive a client request to establish a session with a virtual server. The client and the virtual server can communicate using a presentation services protocol over a lower-level protocol. The device can select a node on a network to use for the session between the client and the virtual server. The device can cause an installation of one or more network stacks on the node, the one or more network stacks configured to communicate with the client and the virtual server using the presentation services protocol over the lower-level protocol and to handle retransmissions of packets between the client, the node, and virtual servers. The device can cause each of the client and the virtual server to establish the session via the node.

### FIELD OF THE DISCLOSURE

The present application generally relates to computing systems and environments, including but not limited to systems and methods for managing network communication.

### BACKGROUND

Network traffic can be handled using a wide variety of network devices and services. Network traffic can also vary widely based on the types of devices and systems that users utilize and the network content they access. Sometimes network traffic can traverse different network devices operating in different configurations and across different networks.

### SUMMARY

This summary is provided to introduce a selection of concepts in a simplified form that are further described below in the Detailed Description. This Summary is not intended to identify key features or essential features, nor is it intended to limit the scope of the claims included herewith.

When deployed between a client and a server, a device (e.g., a gateway, a server,) can act as a proxy that forwards the network traffic between the client and the server and retransmit network data packets that may be lost during the transmission. In the instances in which some network traffic is lost, the latency of the retransmissions of the lost network packets by the proxy device can be affected by the distance between the device and the client or the server as well as by whether the device can retransmit the packets by itself rather than rely on the server or the client to receive the packets which need to be retransmitted. While adding additional devices closer to the proximity of the client and the server could potentially reduce some of the latency associated with lost network packets retransmissions, such a solution can be costly and time consuming.

The present solution overcomes these challenges by reconfiguring nodes on existing third party networks, such as third party content delivery networks (CDNs) or edge networks, to act as intermediary proxy devices. As CDN and edge networks can be located closer to the destination devices (e.g., client or the virtual server) their response times can be shorter, thereby reducing the latency of the lost network packet retransmissions. The present solution can configure nodes on third party networks to establish sessions between the clients and servers that may use different network stacks for their network communication, thereby allowing the reconfigured third party network nodes to act as gateways enabling communication between clients and remote virtual servers that utilize different network stacks, while also providing efficient and low-latency retransmission of any lost network data packets.

In some aspects, the present solution can relate to a method. The method can include receiving, by a device, a request. The request can be from a client device to establish a session with one or more virtual servers. The client device and the one or more virtual servers can communicate using at least a presentation services protocol over one or more lower-level protocols. The method can include selecting, by the device, one or more nodes from one or more networks to use for the session between the client device and the one or more virtual servers. The method can cause, by the device, an installation of one or more network stacks on the one or more nodes of a network of the one or more networks. The one or more network stacks can be configured to communicate with the client device and the one or more virtual servers using at least the presentation services protocol over the one or more lower-level protocols. The one or more network stacks can be configured to handle retransmissions of packets between the client device, the one or more nodes, and the one or more virtual servers. The device can cause each of the client device and the one or more virtual servers to establish the session via the one or more nodes.

The method can include receiving, by the device, the request from a workspace application of the client device to establish the session with the one or more virtual servers. The one or more virtual servers can include at least one of a virtual desktop application or a virtual application. The method can include causing, by the device, the one or more nodes to retransmit the packets between the workspace application and the at least one of the virtual desktop application or the virtual application, via the session.

The method can include selecting, by the device, the one or more nodes based at least on one or more locations of the one or more nodes relative to one of the one or more virtual servers or the client device. The presentation services protocol can include one of an independent computing architecture (ICA) protocol or remote desktop protocol (RDP). The one or more network stacks can include a first network stack configured to communicate with the client device and a second network stack configured to communicate with the one or more virtual servers. The device can include one of a server hosting the one or more virtual servers or a gateway between the client device and the server.

The method can include communicating a uniform resource identifier (URI) of the one or more nodes to each of the client device and the one or more virtual servers. The client device and the one or more virtual servers can connect to the one or more nodes using the URI. The method can include communicating one or more security certificates of each of the client device and the one or more virtual servers to the one or more nodes to establish secure connections between the one or more nodes and each of the client device and the one or more virtual servers. The method can include the client device and one or more nodes select a lower-level protocol to communicate the presentation services protocol based at least on network conditions between the client device and the one or more nodes. The one or more network stacks of the one or more nodes can be configured to communicate with the client device using a first lower-level protocol and to communicate with the one or more virtual servers using a second lower-level protocol different from the first lower-level protocol.

In some aspects, the present solution relates to a system. The system can include one or more processors coupled to memory. The one or more processors can be configured to receive a request from a client device to establish a session with one or more virtual servers. The client device and the one or more virtual servers can communicate using at least a presentation services protocol over one or more lower-level protocols. The one or more processors can be configured to select one or more nodes from one or more networks to use for the session between the client device and the one or more virtual servers. The one or more processors can be configured to cause an installation of one or more network stacks on the one or more nodes of a network of the one or more networks. The one or more network stacks can be configured to communicate with the client device and the one or more virtual servers using at least the presentation services protocol over the one or more lower-level protocols. The one or more network stacks can be configured to handle retransmissions of packets of the client device to the one or more virtual servers on behalf of the client device. The one or more processors can be configured to cause each of the client device and the one or more virtual servers to establish the session via the one or more nodes.

The one or more processors can be configured to receive the request from a workspace application of the client device to establish the session with the one or more virtual servers comprising at least one of a virtual desktop application or a virtual application. The one or more processors can cause the one or more nodes to retransmit the packets between the workspace application and the at least one of the virtual desktop application or the virtual application, via the session.

The one or more processors can select the one or more nodes based at least on one or more locations of the one or more nodes relative to one of the one or more virtual servers or the client device. The presentation services protocol can include one of an independent computing architecture (ICA) protocol or remote desktop protocol (RDP). The one or more network stacks can include a first network stack configured to communicate with the client device and a second network stack configured to communicate with the one or more virtual servers.

The one or more processors can include one of a server hosting the one or more virtual servers or a gateway between the client device and the server. The one or more processors can communicate a uniform resource identifier (URI) of the one or more nodes to each of the client device and the one or more virtual servers. The client device and the one or more virtual servers can connect to the one or more nodes using the URI.

The one or more processors can communicate one or more security certificates of each of the client device and the one or more virtual servers to the one or more nodes to use to establish secure connections between the one or more nodes and each of the client device and the one or more virtual servers. The client device and one or more nodes can select a lower-level protocol to communicate the presentation services protocol based at least on network conditions between the client device and the one or more nodes.

A non-transitory computer readable medium storing program instructions for causing at least one processor of a server to receive a request from a client device. The request can be to establish a session with one or more virtual servers. The client device and the one or more virtual servers can communicate using at least a presentation services protocol over one or more lower-level protocols. The instructions can cause the processor to select one or more nodes from one or more networks to use for the session between the client device and the one or more virtual servers. The instructions can cause the processor to cause an installation of one or more network stacks on the one or more nodes of a network of the one or more networks. The one or more network stacks can be configured to communicate with the client device and the one or more virtual servers using at least the presentation services protocol over the one or more lower-level protocols. The one or more network stacks can be configured to handle retransmissions of packets of the client device to the one or more virtual servers on behalf of the client device The instructions can cause the processor to cause each of the client device and the one or more virtual servers to establish the session via the one or more nodes.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of an appliance or a server for processing communications between a client and a server, in accordance with an illustrative embodiment;

FIG. 3 is a block diagram of a virtualization environment, in accordance with an illustrative embodiment;

FIG. 4 includes a block diagram of an example system for establishing a session, on a third party network node retransmitting lost network data packets, between a client and a server that communicate using different communication protocols, in accordance with an illustrative embodiment;

FIG. 5 includes an example TCP communication between a client and a server utilizing different network stacks, via a network node conforming the traffic to the network stack of the destination device, in accordance with an illustrative embodiment;

FIG. 6 includes an example UDP communication between a client and a server utilizing the same network stacks, via a network node, in accordance with an illustrative embodiment;

FIG. 7 includes an example of a communication process provided by a network node to a client and a server, where the client uses UDP protocol and the server uses TCP protocol, in accordance with an illustrative embodiment;

FIG. 8 includes an example of a communication process provided by a network node to a client and a server, where the client uses TCP protocol and the server uses UDP protocol, in accordance with an illustrative embodiment;

FIG. 9 includes a flow diagram of an example method of establishing a session, on a third party network node retransmitting lost network data packets, between a client and a server that communicate using different communication protocols, in accordance with an illustrative embodiment;

### DETAILED DESCRIPTION

Gateway devices can be used as proxies for communication between client devices and remote servers, including virtual or physical servers. Sometimes, the clients and servers can communicate using different network protocols or different network stacks. Gateway devices can help manage the communication between the client and the server as well as retransmit any network packets that may be lost during prior transmissions. However, when a gateway device is located far from the client device or the server, latencies can be introduced. For instance, in the event of a lost network packet to be retransmitted, a gateway device may rely on a remote server (or virtual servers) in order to recover and retransmit the lost network packets. While adding additional gateway devices closer to the proximity of the client or the server could presumably reduce the latency and improve the speed of the network traffic retransmissions, such a solution can be costly and time consuming.

The present solution provides a cost effective and efficient technique to provide low latency retransmission of the network traffic between a client and a remote server (e.g., virtual server) by reconfiguring the nodes of a third party network, such as a third party content delivery network (CDN) or a third party edge network. The present solution can configure an edge or a CDN network node to form a session between a client and a virtual server that may communicate using different communication protocols or network stacks. For example, upon receiving a request to form a session between a client and a virtual server, a gateway device that can select a third party network node which to reconfigure to act as a proxy device. The gateway device can install on the network node configuration modules to enable the node to support the session between the client and the virtual server despite them communicating using different network stacks. The configuration modules can also cause the network node to provide low latency retransmission of any dropped network traffic between the client and the server. The gateway can also cause the third party network node to establish the session between the client and the server via the network node so as to enable the client and the server to communicate using their network stacks.

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and method for providing virtualized application delivery

Section D describes embodiments of systems and methods for providing remote access over third party networks.

### A. Network and Computing Environment

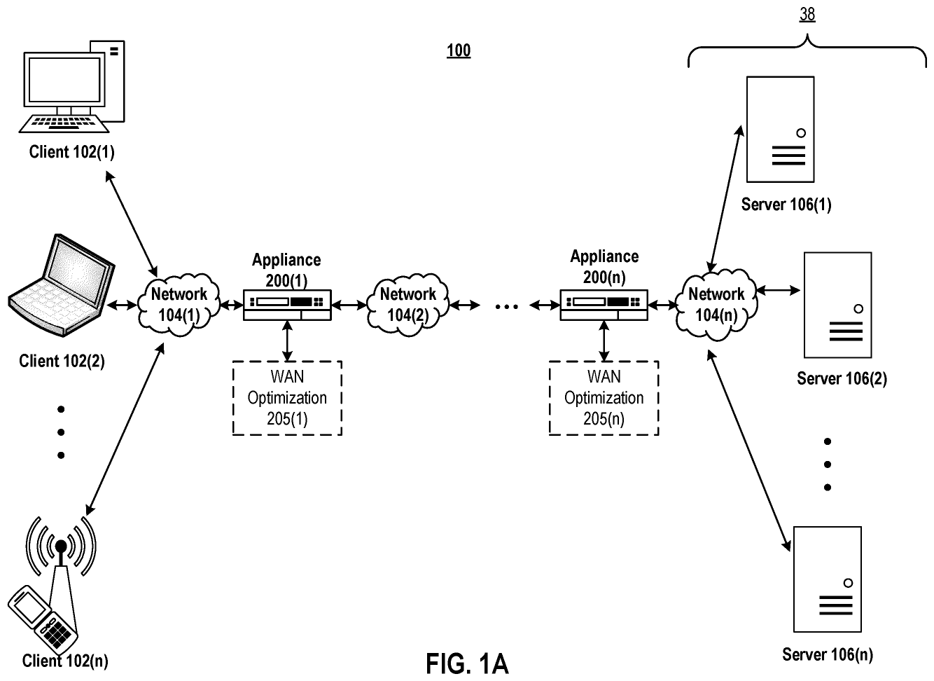

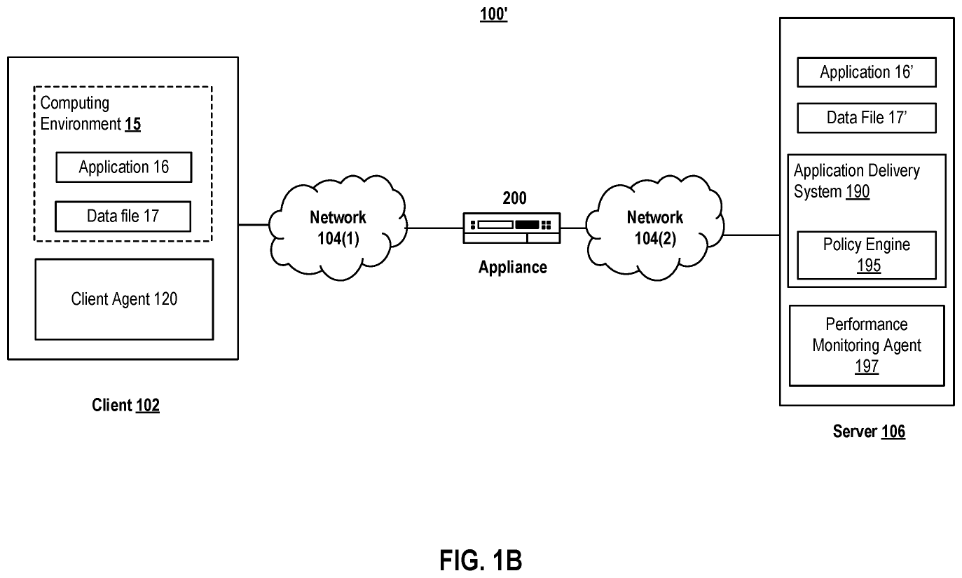

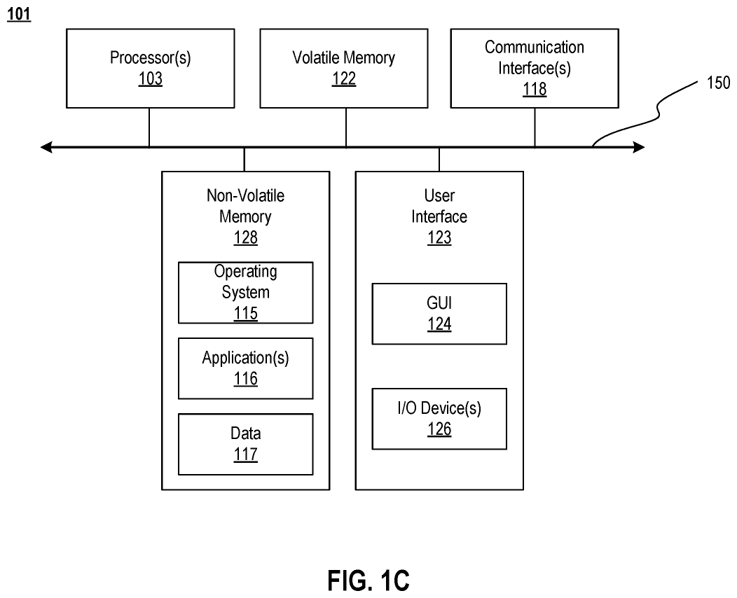

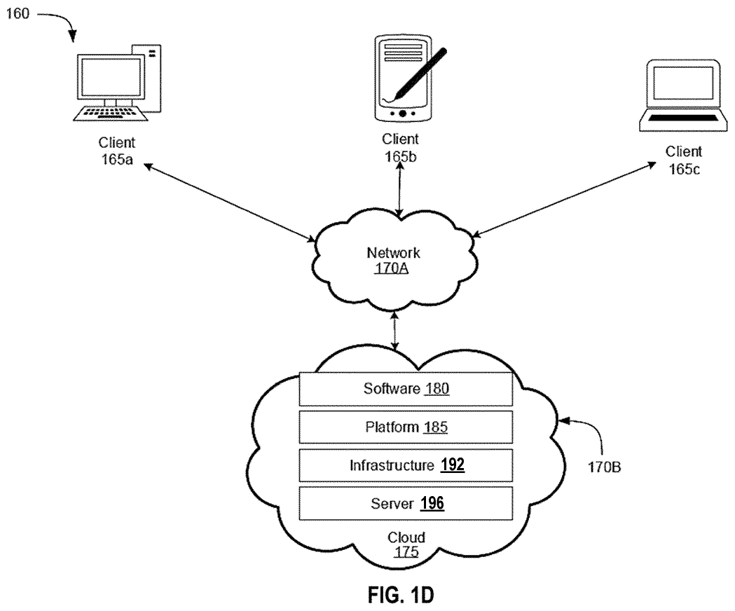

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix DaaS™ (formerly Citrix Virtual Apps and Desktops, XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, FL, the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 196, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 can include any functionality or features of clients 102 and vice versa. Clients 165 may include, e.g., thick clients, thin clients, and zero clients. The cloud 175 may include back end platforms, e.g., servers 196, storage, and server farms or data centers. Clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 196 that are maintained by third parties to clients 165 or the owners of the clients 165. The servers 196 may be located off-site in remote geographical locations as disclosed above or otherwise. Public clouds 175 may be connected to the servers 196 over a public network 170. Private clouds 175 may include private servers 196 that are physically maintained by clients 165 or owners of clients 165. Private clouds 175 may be connected to the servers 196 over a private network 170. Hybrid clouds 175 may include both the private and public networks 170A, 170B and servers 196.

The cloud 175 may include back end platforms, e.g., servers 196, storage, server farms or data centers. For example, the cloud 175 can include or correspond to a server 196 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 192. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

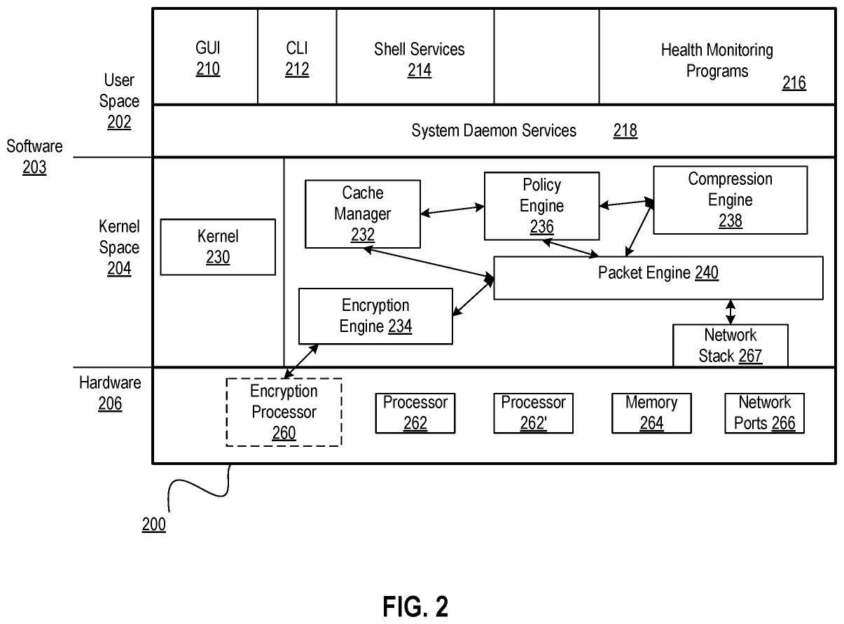

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 203 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, FL, the teachings of which are hereby incorporated herein by reference.

### C. Systems and Methods for Providing Virtualized Application Delivery Controller

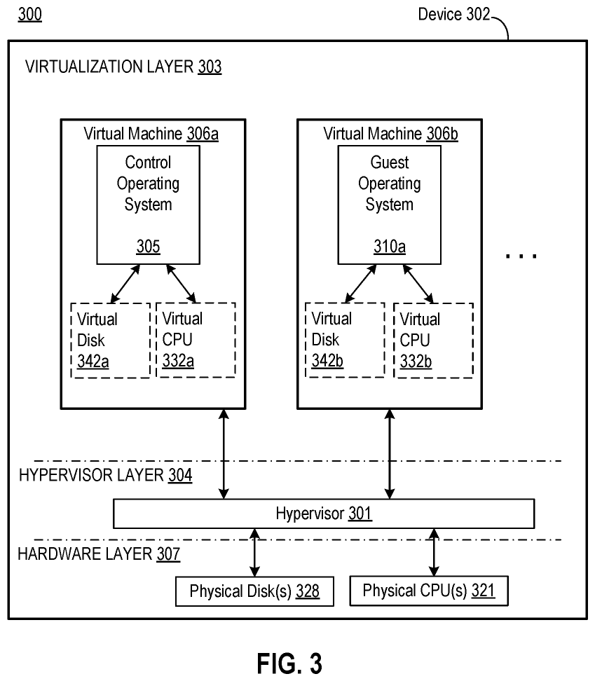

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, FL. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

D. Providing Remote Access over Third Party Networks

A gateway device, such as an appliance 200 or a server 106, can be deployed between a client 102 and a server 106 providing one or more applications via virtual servers (e.g., virtual machines 306). For example, a virtual application of the virtual server can include any application or a service of Citrix Virtual Applications and Desktops (CVAD) or the Citrix Workspace Suite, provided by the Citrix Systems, including, for example, a virtual desktop or a virtual application of the Citrix Workspace. The virtual application can be provided by the virtual server that utilizes one or more presentation layer protocols, such as remote desktop protocol (RDP) or independent computing architecture (ICA) protocols over one or more packetization protocols, such as enlightened data protocol (EDT) or transmission control protocol (TCP). The virtual server can use any combination of multilayer protocols for its network traffic communication via a virtual delivery agent (VDA) deployed on the same virtual server. The access and use the virtual server provided remote service, the client device 102 can utilize any local client application that can interact with the virtual application of the virtual server, such as, for example, any client side application, function or an agent of the aforementioned Citrix Workspace Suite.

In the event that some network traffic between the client and the virtual server is lost in transmissions, the gateway device can provide retransmission of lost network traffic. For example, when data packets are lost from the client side, retransmission of the lost network data packets can be implemented by the gateway without relying on the VDA of the remote virtual server. However, when retransmission of lost data packets relies on the communication with the virtual server, additional delays can occur, based on the distance between the gateway and the location of the virtual server, which makes VDA-side packet retransmission usually more delayed. Likewise, in the instances in which the client and server communicate using protocols whose internal contents may be difficult to monitor or track, in the event of network traffic loss, the gateway device may have to rely on the virtual server (e.g., VDA) to recover the lost network packets, incurring further delays. These delays with respect to VDA-side lost data packet retransmission can be addressed by introducing additional point of presence (POP) network interfaces at locations closer to the endpoints (e.g., the client and/or virtual server). However, adding POP interfaces to service different clients and remote virtual servers may be costly and involve additional cloud investment.

The present solution relies on a more cost-effective approach that leverages the ubiquitous and elastic third party networks (e.g., CDNs and edge networks) to select nodes on such networks to serve as proxies that provide a more efficient, available and cost-effective network packet retransmission. Since third party networks can include hundreds of POPs, each one of which can have one or more leased circuits to adjacent HTTP servers, the present solution can utilize nodes on such HTTP CDN or edge networks to interconnect clients with the virtual servers. In such an arrangement, when a client application connects to an application (e.g., virtual application) via a VDA of a virtual server, the third party network node can be configured to be used as an internet hop-off point to send the HTTP request to the VDA by translating ICA messages into HTTP messages (e.g., requests or responses). Likewise, the configured network node can process the network traffic between two different protocols, such as the EDT and TCP, as well as two different network stacks, allowing the client 102 and the server 106 to use a presentation level protocol over different lower-level protocols in their network stack for their communication via the node of the third party network.

The present solution can, for example, use the appliance 200 to receive a request from a client 102 to establish a session with an application provided by the virtual server. While the appliance 200 can initially establish the session between the client and the virtual server, the appliance 200 can then migrate the established session and its connections to a node of a third party network that is located closer to either one or both of the end points of the session, such as the virtual server or the client. The third party network node can then take over the session between the client 102 and the virtual server and can continue to serve as the proxy between the client and the virtual server even when the client and the virtual server communicate using different network protocols. The third party network node can also provide retransmission of lost network packets with a lower delay due to its closer proximity to the end point (e.g., virtual server or the client).

To implement this functionality, the appliance 200 can configure a third party node (e.g., a CDN node) with the VDA of the virtual server as the ‘origin server’ using a new unique resource identifier (URI). The new URI can be communicated to client 102 application (e.g., client-side Workspace application) along with certificates for both the application on the client and the VDA on the virtual server. The client application can then connect to the new URI (e.g., to the node). As each one of the end points (e.g., client or the virtual server) can use a different protocol for communicating with the other end point, different protocols can be used by different end points in the same session. For instance, the client can request, or the node can decide to change the protocols during the communications between the end points. For example, a communication from the sender can use a first set of protocols and the node can conform to the first set of protocols of the sender to a second set of protocols used by the receiver, prior to forwarding the communication to the receiver. Such changes to the protocols used, can be done, for example, in response to the network conditions or heuristics in the connection between the node and the end points.

For example, the client can request to change the protocol or a network stack to a different protocol, such as Websocket, or a different network stack. This can cause subsequent messages over that TCP connection to go from Workspace client to the CDN, across the CDN's network, and to the VDA. An end-to-end encrypted can be established between the client and the virtual server. For example, the VDA can receive ICA over the new channel. From the client-side Workspace application to the virtual server side VDA an end-to-end encrypted virtualization session, via the node, can be established. The end-to-end encryption, such as via the ICA protocol, can be used for the session, even if the client 102 and virtual server utilize different lower-level communication protocols.

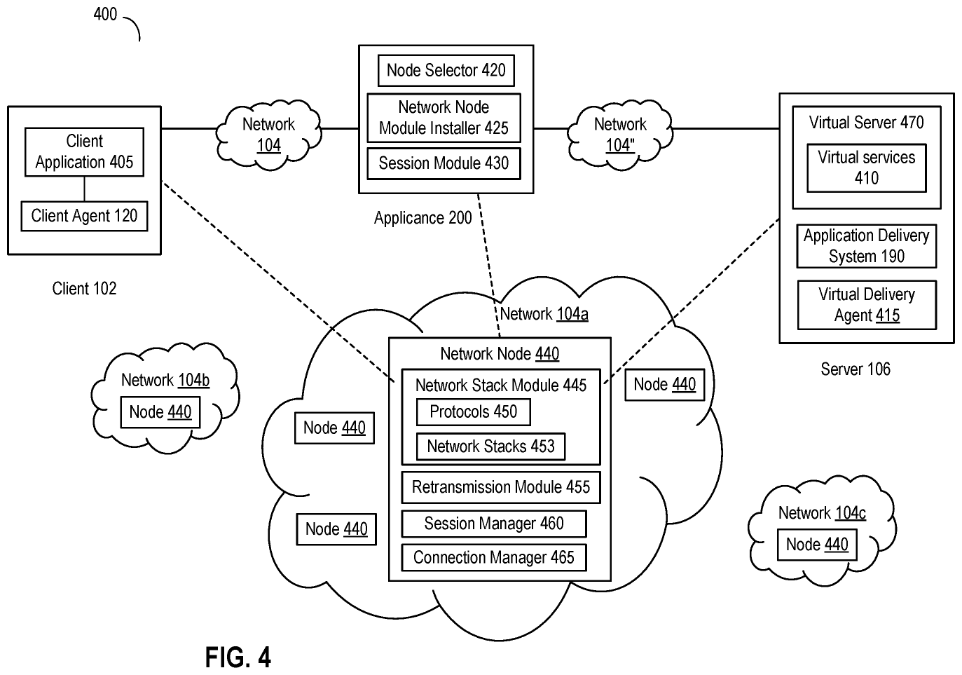

Referring now to FIG. 4, a system 400 for establishing a session, on a third party network node retransmitting lost network data packets, between a client and a server that communicate using different communication protocols, is illustrated. A client 102 can utilize a client application 405 executing on the client 102 to access, via a network 104 and network 104″, one or more virtual services 410 provided on a virtual server 470 of a remote server 106 that also operates a virtual delivery agent 415. The client 102 and server 106 can communicate via an intermediary appliance 200 that can include a node selector 420, a network node module installer 425 and a session module 430. System 400 can further include any number of third party networks, such as networks 104a, 104b, 104c that can correspond to various CDNs or edge networks having any number of network nodes 440. Appliance 200 can select a particular network node 440 on a third party network 104a-n (e.g., CDN or edge network) to establish a session or proxy the session between the client 102 and server 106 or appliance 200. The selected network node 440 can include a network stack module 445 that can include network communication protocols 450 and network stacks 453. Network stack module 445 can be installed by the appliance 200 to configure the network node 440 to communicate with the client 102 and virtual server 470 using any communication protocols 450 in any network stacks 453. The network node 440 can also include a retransmission module 455 for configuring the network node 440 to retransmit lost network data packets, as well as a session manager 460 and a connection manager 465 for establishing and managing the sessions and connections between client 102 and virtual server 470, via the network node 440.

Client application 405 can include any application operating on a client 102. Client application 405 can include any combination of hardware and software, such as computer code, functions or instructions operating on processors (e.g., 260, 262) for utilizing or communicating with virtual services 410 on a virtual server 470. Client application 405 can be, or include any functionality of, an application 16 operating in a computing environment 15. For instance, client application 405 can be any application utilizing real-time data communications, such as applications for streaming graphics, streaming video and/or audio or other data, delivery of remote desktops or workspaces or hosted services or applications, including IaaS, DaaS, WaaS, SaaS or PaaS. Client application 405 can include, for example, an application or a function of a Citrix Workspace Suite for execution on a client 102. For example, client application 405 can include a function or an agent of an application of a Citrix Workspace Suite (e.g., Workspace application) that can be provided by as well as access, interact with or utilize virtual services 410.

Virtual services 410 can include any services or applications provided by a server 106 or a virtual server 470. Virtual services 410 can include applications or services executed on, or provided by, a virtual machine 306. Virtual service 410 can execute in a container on one or more servers 106 or on a cloud 175. Virtual services 410 can include applications or services provided by a Workspace application on a virtual server 470, such as the Citrix Virtual Apps and Desktops. Virtual services 410 can include any hosted service provided as an IaaS, DaaS, WaaS, SaaS or a PaaS.

Virtual server 470 can include any virtual machine 306a providing the functionality of a server 106. Virtual server 470 can include a contained environment in which one or more processors (e.g., 260) process one or more sandboxed applications performing functionality of a server 106. Virtual server 470 can include and execute computer code, instructions and functions of any virtual services 410.

Virtual delivery agent (VDA) 415 can include any agent operating on a physical (e.g., 106) or virtual machine 306 that serves computer network or online content to the clients 102. VDA 415 can include computer code, instructions or functions to enable virtual servers 470 to register with a controller function, which in turn can allow the virtual servers 470 to provide resources to the clients 102. VDA 415 can include the functionality to establish and manage the connections between the virtual server 470 (e.g., virtual machine 306) and one or more remote clients 102. VDA 415 can verify that a license is available for the client 102 or a particular session and can apply policies that are configured for the session of the client 102. VDA 415 can communicate with clients 102 on behalf of the virtual server 470 and can allow single sessions or multi-session operations on the virtual server 470, allowing a single or multiple users to operate the virtual server 470 at a time. VDA 415 can communicate with the clients 102 via a TCP port.

Node selector 420 can include any combination of hardware and software for selecting a network node 440. Node selector 420 can include functionality to identify one or more third party networks and one or more network nodes 440 on such networks. Node selector 420 can identify an edge network, such as a network 104. Node selector 420 can identify a CDN, such as a network 104. Node selector 420 can identify a network node 440 within an identified network. Node selector 420 can select the network node 440 based on the performance of the network node 440. Node selector 420 can select the network node 440 based on the geographic location of the underling hardware of the network node 440.

Network node module installer 425 can include any combination of hardware and software for providing capability to a network node 440 to perform retransmission of the network data packets that are lost or dropped on the way to their destination (e.g., client 102 or virtual server 470). Network node module installer 425 can provide capability to a network node 440 to enable communication between client 102 and server 106 via different network communication protocols 450. Network node module installer 425 can include a combination of computer code, instructions and functions that can be processed by a processor (e.g., 103, 260, 262) to install on a selected network node 440 a module to configure the network node 440 to retransmit lost or dropped network packets. Network node module installer 425 can install, or cause the installation of, the retransmission module 455 on a network node 440. Network node module installer 425 can install, or cause the installation of, the network stack module 445, session manager 460 or connection manager 465 on the network node 440.

Session module 430 can include any combination of hardware and software for establishing and managing a session between client 102 and a remote virtual server 470 by an appliance 200. Session module 430 can include the functionality to establish a session or a connection between a client 102 and virtual server 470. Session module 430 can establish a session or a connection in response to a request, such as a request by a client 102. Session module 430 can include the functionality to migrate the established session (e.g., between a client 102 a virtual server 470) to a network node 440. Session module 430 can include the functionality to provide URIs and security certificates of the network node 440 to the client 102 and virtual server 470.

Network node 440 can include any node on a network, such as network 104a or any other third party network. Network node 440 can include a node or an end point on CDN network 104. Network node 440 can include a node or an end point on an edge network 104. Network node 440 can include an interface on a cloud environment, such as cloud 175. Network node 440 can include or operate on one or more physical devices (e.g., servers 106) or one or more virtual machines 306, or any combination thereof. Network node 440 include any functionality for providing network traffic forwarding, retransmission and proxy services to clients 102 and servers 106, including virtual servers 470. Network node 440 can be configured to perform network traffic operations based on a configuration from an appliance 200. The configuration can occur in response to installation of from the network node module installer 425.

Network stack module 445 can include any combination of hardware and software to allow network devices (e.g., clients 102 and virtual servers 470) to communicate with each other while using different protocols 450 or different network stacks 453. Network stack module 445 can include the functionality to allow network device using one network communication protocol to communicate with another device using a different network protocol, via the network node 440.

Network stack module 445 can establish and implement any network stack 435. The network stack 453 can include any implementation of a computer networking protocol suite or a family that can be used in a communication. The network stack 453 can include a combination of networks protocols 450 at various levels or layers that can be used together to implement a particular communication in a session or a connection between a client 102 and virtual server 470. Network stack module 445 can select a protocol 450 to implement for a particular session or a connection between the node 440 and either of the end-points or intermediaries (e.g., virtual server 470, appliance 200 or client 102). For example, network stack module 445 can select a protocol, such as a lower-level protocol 450, for a connection between the node 440 and an end point or intermediaries (e.g., virtual server 470, appliance 200 or client 102). The protocol can be selected based on any one or more of: characteristics of a network, such as a network 104a on which node 440 is located, characteristics of network 104 between client 102 and the node 440, characteristics of network 104″ between the node 440 and the virtual server 470, any loss characteristics related to a connection or a session, a type of application 405 or virtual services 410 being used for communication.

Network stack module 445 can include the functionality to establish a network stack 453 comprising any combination of protocols 450. Network stack 445 can enable the network node 440 to communicate using any of the network stack protocols 450. Network stack module 445 can include the functionality to implement a first network stack 453 for communications between a client 102 and a network node 440 and a second network stack 453 for communications between a virtual server 470 and the network node 440. Network stack module 445 can enable communication between client 102 and virtual server 470, where client 102 utilizes a first network stack 453 and virtual server 470 utilizes a second network stack 453 that includes network protocols 450 that are different form the network protocols 450 in the first network stack 453.

Network stack module 445 can include the functionality to parse, monitor, analyze, decapsulate or encapsulate any network traffic using any protocol 450. Network stack module 445 can include the functionality to operate using Web Socket communication protocol, providing a full duplex communication channels over a TCP connection. Network stack module 445 can include the functionality to convert or translate communication network traffic from one or more protocols 450 into a communication network traffic using a different one or more protocols 450.

For example, network stack module 445 can allow for a client 102 that communicates via a UDP protocol 450g and a UDP connection to exchange communication with a virtual server 470 that communicates using TCP protocol 450d and a TCP connection. For example, network stack module 445 can receive communication from a client 102 using a network stack 453 that includes an end-to-end encryption protocol. The end-to-end encryption protocol can be layered over an EDT 450e protocol, which can be over a datagram transport layer security (DTLS) protocol 450f, which can be over a UDP 450g protocol. Once received by a network node 440, the network stack module 445 can and remove or un-package UDP 450g, DTLS 450f and EDT 450e, to then repackage the network traffic into a network stack 453 that includes transport layer security (TLS) protocol 450c over TCP to retransmit the same communication to the intended server 106 or virtual server 470 using an end-to-end encryption protocol over a TLS 450c and over a TCP 450d protocol.

Protocols 450 can be any network traffic stack protocols. Protocols 450 can be open systems interconnection (OSI) model protocols. Protocols 450 can include any protocol for network communication, including for example a physical layer protocol, a data link layer protocol, a network layer protocol, a transport layer protocol, a session layer protocol, a presentation layer protocol, or an application layer protocol. Protocols 450 can include a presentation layer protocol, such as ICA protocol 450a. Protocols 450 can include an application layer protocol, such as a WebSocket protocol 450b. Protocols 450 can include TLS 450c. Protocols 450 can include TCP 450d. Protocols 450 can include EDT 450e. Protocols 450 can include DTLS 450f. Protocols 450 can include UDP 450g. Protocols 450 can include any network traffic protocol of any network stack and at any layer.

Retransmission module 455 can include any combination of hardware and software for retransmitting lost or dropped network data packets. Retransmission module 445 can include the functionality to identify network packets that are dropped or lost during the transmission. Retransmission module 445 can include the functionality to track network packets that were sent toward their destination (e.g., client 102 or virtual server 470). Retransmission module 445 can include the functionality to track network packets that were received at their destination. Retransmission module 445 can acquire lost network packets and resend them to their destination. Retransmission module 455 can store the transmitted network packets in a local cache or memory (e.g., 122, 264) and then in response to identifying that the network packets were lost, retrieve copies of the lost network packets from the memory and resend them to their destination. Retransmission module 455 can acquire lost data packets from a virtual server 470 or a client 102 and retransmit the lost data packets to the intended destination.

Session manager 460 can include any functionality for establishing and managing sessions between clients 102 and virtual servers 470. Session manager 460 can receive a session from an appliance 200. Session manager 460 can receive URI of client 102 and virtual server 470. Session manager 460 can receive security certificates relating client 102 and virtual server 470. Session manager 460 can establish a session with a client 102 based on URI of the network node 440 received by a client 102 from appliance 200. Session manager 460 can establish a session with a virtual server 470 based on a URI of the network node 440 received by the virtual server 470 from appliance 200. Session manager 460 can establish a session based on security certificates received by client 102 and/or virtual server 470.

Connection manager 465 can include any functionality for establishing and managing connections between clients 102 and virtual servers 470. Connection manager 465 can establish a connection with a client 102 or establish a connection with a virtual server 470. Connection manager 465 can establish connections in response to one or more security certificates. Connection manager 465 can accept initiatives by client 102 to establish a connection and establish a connection in response to a request by a client 102. Connection manager 465 can accept initiative by virtual server 470 to establish a connection and establish the connection in response to a request by the virtual server 470. Connection manager 465 can establish a connection in response to a message from an appliance 200. Connection manager 465 can establish a Web Socket protocol based TCP connection between client 102 and server 106 or virtual server 470.

The present solution can relate to a system 400 in which one or more processors (e.g., 103, 262) can be coupled with memory (e.g., 122, 128, or 264). The memory can include and the processors can execute computer instruction or code that can provide configurations to the one or more processors (e.g., 103, 262) of the functionality of the system 400. The one or more processors 103 or 262 of an appliance 200 can be configured to receive a request from a client 102 to establish a session with one or more virtual servers 470. The client 102 and the one or more virtual servers 470 can communicate over one or more networks 104 using at least a presentation services protocol (e.g., Citrix ICA) over one or more lower-level protocols (e.g., TCP, UDP). The one or more processors 103 or 262 of the appliance 200 can be configured to select one or more nodes 440 from one or more networks (e.g., 104a-n) to use for the session between the client device 102 and the one or more virtual servers 470. The one or more processors 103 or 262 of the appliance 200 can be configured to cause an installation, by a network node module installer 425, of one or more network stacks 453 on the one or more nodes 440 of a network 104 of the one or more networks 104a-n. The one or more network stacks 453 can be configured to communicate with the client device 102 and the one or more virtual servers 470 using at least the presentation services protocol 450 (e.g., Citrix ICA) over the one or more lower-level protocols (e.g., UDP or TCP). The installation can configure the node 440 to handle retransmissions of packets of the client 102 device to the one or more virtual servers 470 on behalf of the client device 102. The one or more network stacks 453 can be configured to handle retransmissions of packets of the client 102 device to the one or more virtual servers 470 on behalf of the client device 102. The one or more network stacks 453 can allow or enable the node 440 to handle retransmissions of packets of the client 102 device to the one or more virtual servers 470 on behalf of the client device 102. For example, processing, monitoring, parsing, analyzing, or handling one or more network stacks 453 by the node 440 can allow the node 440 to handle retransmissions of packets of the client 102 device to the one or more virtual servers 470 on behalf of the client device 102. The one or more processors 103 or 262 of the appliance 200 can be configured to cause each of the client device 102 and the one or more virtual servers 470 to establish the session via the one or more nodes 440.

The one or more servers 103 or 262 can receive the request from a workspace application 405 of the client device 102 to establish the session with the one or more virtual servers 470 comprising at least one of a virtual desktop application 410 or a virtual application 410. The one or more processors 103 or 262 can cause the one or more nodes 440 to retransmit the packets between the workspace application 405 and the at least one of the virtual desktop application 410 or the virtual application 410, via the session.

The one or more processors 103 or 262 can select the one or more nodes 440 based at least on one or more locations of the one or more nodes 440 relative to one of the one or more virtual servers 470 or the client device 102. The presentation services protocol 450 can include a remoting protocol. The remoting protocol can include any protocol for providing a remote access to a remote application or a resource, such as for example Independent Computing Architecture (ICA) protocol (e.g., 450a) or Remote Desktop Protocol (RDP). The remoting protocol can include a presentation layer protocol. The one or more network stacks 453 can include a first network stack 453 configured to communicate with the client device 102 and a second network stack 453 configured to communicate with the one or more virtual servers 470.

The one or more processors 103 or 262 can be a part of a server 106 hosting the one or more virtual servers 470. The one or more processors 103 or 262 can be a part of a gateway 200 between the client device 102 and the server 106. The one or more processors 103 or 262 can communicate a uniform resource identifier (URI) of the one or more nodes 440 to each of the client device 102 and the one or more virtual servers 470. The client device 102 and the one or more virtual servers 470 can connect to the one or more nodes 440 using the URI. The one or more processors 103 or 262 can communicate one or more security certificates of each of the client device 102 and the one or more virtual servers 470 to the one or more nodes 440 to use to establish secure connections, by connection manager 465, between the one or more nodes 440 and each of the client device 102 and the one or more virtual servers 470. The client device 102 and one or more nodes 440 can select a lower-level protocol 450 to communicate the presentation services protocol 450 based at least on network conditions between the client device 102 and the one or more nodes 440.

The present solution can relate to a non-transitory computer readable medium (e.g., 122) that can storing program instructions. The instructions can cause at least one processor (e.g., 103, 262) of a server 106 to receive a request from a client device 102 to establish a session with one or more virtual servers 470. The client device 102 and the one or more virtual servers 470 can communicate using at least a presentation services protocol 450 over one or more lower-level protocols 450. The instructions can cause at least one processor 103 or 262 to select one or more nodes 440 from one or more networks 104a-n to use for the session between the client device 102 and the one or more virtual servers 470. The instructions can cause at least one processor 103 or 262 to cause an installation of one or more network stacks 453 on the one or more nodes 440 of a network 104 of the one or more networks 104a-n. The one or more network stacks 453 can be configured to communicate with the client device 102 and the one or more virtual servers 470 using at least the presentation services protocol 450 over the one or more lower-level protocols 450. The installation can configure the node 440 to handle retransmissions of packets of the client device 102 to the one or more virtual servers 470 on behalf of the client device 102. The one or more network stacks 453 can configure the node 440 to handle retransmissions of packets of the client 102 device to the one or more virtual servers 470 on behalf of the client device 102. The instructions can cause at least one processor 103 or 262 to cause each of the client device 102 and the one or more virtual servers 470 to establish the session via the one or more nodes 440.

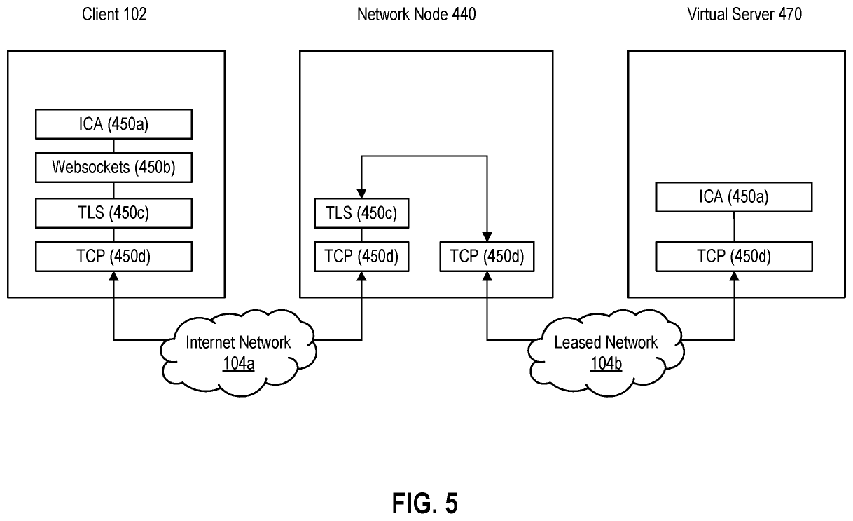

Referring now to FIGS. 5-8, examples of various implementations of the network node 440 acting as a proxy between the client 102 and virtual server 470 communicating using different network protocols 450 or different network stacks 453 are illustrated. In the examples of FIGS. 5-8, network node 440 modifies or restructures communications from 102 to the virtual server 470 to conform to the network stack 453 of the virtual server 470 and modifies or restructures communications from the virtual server 470 to the client 102 to conform to the network stack 453 of the client 102.

More specifically, FIGS. 5-8, the network node 440 manages network communications between client 102 and virtual server 470 by modifying network traffic to conform the network traffic of the source device to the network stack 453 of the destination devices. In doing so, network node 440 maintains the session between the client 102 and virtual server 470 and enables their communication between the client 102 and virtual server 470. For example, the network node 440 can receive network data packets from client 102 destined to the virtual server 470, where the client's network data is encapsulated, structured or organized according to a first network stack 453 of the client 102. The network node 440 can then deconstruct and modify or the network data from the client 102 to conform to the second network stack 453 of the virtual server 470. The network node 440 can then send to the virtual server 470 the reconstructed, modified or rearranged network packets so as to be encapsulated, structured or organized in accordance with the second network stack 453 of the virtual server 470. For example, the network node 440 can receive network data packets from virtual server 470 destined to the client 102, where the virtual server's network data is encapsulated, structured or organized according to the second network stack 453 of the virtual server 470. The network node 440 can then deconstruct and modify or the network data from the virtual server 470 to conform to the first network stack 453 of the client 102. The network node 440 can then send to the client 102 the reconstructed, modified or rearranged network packets so as to be encapsulated, structured or organized in accordance with the first network stack 453 of the client 102. By acting as a proxy and confirming network transmissions from the client 102 and the virtual server 470 in accordance with each other's network stack 453, the network node 440 can maintain the session and communications between the client 102 and virtual server 470.

The network node 440 can include an edge node or a CDN reconfigured with a network stack module 445 and a retransmission module 455 installed on the network node 440 by an appliance 200. While configuring the network node 440, the appliance 200 can send to the client 102 the URI of the network node 440 to use by the application 405. For example, appliance 200 can send to the client 102 “citrix-edge-vda://1.2.3.4/customer-b/uniqueid” along with security certificates for both the client application 405 (e.g., Workspace) and the VDA 415 of the virtual server 470. The client application 405 can then connect to the received new URI using the EDT protocol. Over the new session now formed between the client application 405 and the VDA 415 of the virtual server 470, a session can be established using the ICA protocol as the presentation layer protocol. The connection can then be established, and ICA network traffic can be transitioned to use the network node 440 managed session for the communications between the client 102 and the server 106 (e.g., virtual server 470).

FIG. 5 illustrates an example of a communication process between a client 102 and a virtual server 470 that communicate, via a network node 440, using different network stacks 453. In the illustrated example, a client 102 communicates with a network node 440 over an internet network 104a. Client 102 sends its network data (e.g., network data packets) packaged, encapsulated or otherwise formed in accordance with a first network stack 453 of the client. The first network stack 453 of the client 102 includes ICA protocol 450a as the presentation layer protocol over a Web Socket protocol 450b, which is over a TLS protocol 450c and which is over a TCP protocol 450d. Each of the protocols 450a-450d can be combined together into the first network stack 453 in accordance with which network traffic from client 102 is formed, organized or structured.

The network node 440 can communicate with the virtual server 470 over a leased network 104b. The virtual server 470 can send its network data (e.g., network data packets) packaged, encapsulated or otherwise formed or structured in accordance with a second network stack 453 of the virtual server 470, which can include ICA protocol as the presentation layer protocol 450a over TCP 450d protocol.

Upon receiving network traffic from client 102, network node 440 can use the network stack module 445 to repackage, reorganize or reconstruct the received network traffic into a destination network stack 453 of virtual server 470. For example, network stack module 445 can monitor, analyze, deconstruct, decapsulate, parse or otherwise unpackage the received TCP 450d and TLS 450c protocol configurations and then construct, structure, encapsulate or package the network traffic from the client 102 using the ICA protocol 450a as the presentation layer protocol over TCP 450d protocol to form the network stack 453 of the virtual server 470. Network node 440 can parse, monitor and store in a local cache memory copies of the network traffic, in order to be able to retransmit the data packets in the event that they are lost. Network node 440 can then forward to the virtual server 470 the network traffic of the client 102 in accordance with the network stack 453 of the virtual server 470.

Upon receiving the network traffic from the network node 440, virtual server 470 can generate and send the network traffic of its own for the client 102 (e.g., data from virtual service 410) and send it to the network node 440. Network traffic from the virtual server 470 can be constructed, encapsulated or packaged in accordance with the network stack of the virtual server 470, having an ICA protocol 450a as the presentation layer protocol over TCP 450d protocol. Upon receiving the network traffic, the network node 440 can parse, monitor and store in a local cache memory copies of the network traffic, in order to be able to retransmit the data packets in the event that they are lost. Network node 440 can deconstruct, decapsulate, or unpackage the received network traffic to reorganize, reform or restructure it in accordance with the network stack of the client 102. The network node 440 can utilize network stack module 445 to add TLS 450c protocol over the TCP 450d protocol and conform the network data of the virtual server 470 in accordance with the network stack 453 of the client 102. Network node 440 can send to the client 102 the network traffic from the virtual server 470 that is reorganized in accordance with the network stack 453 of the client 102.

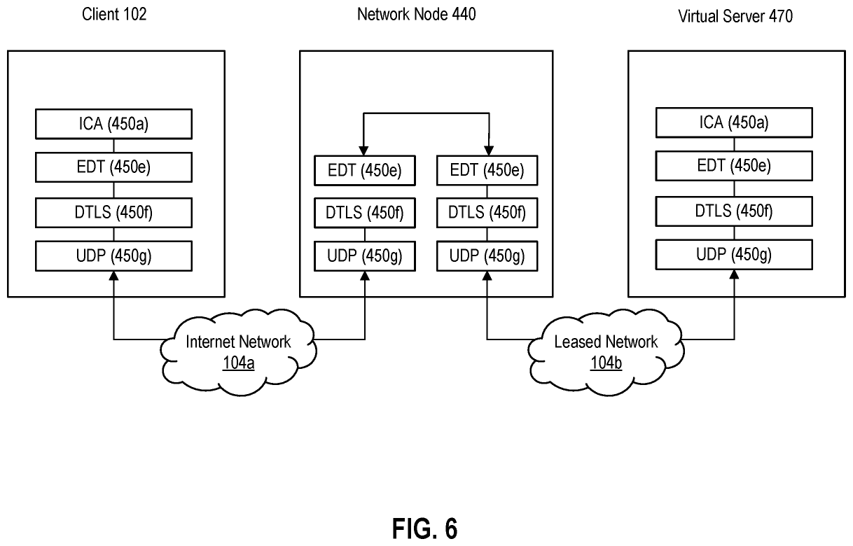

FIG. 6 illustrates an example TCP communication, via a network node, between a client and a server utilizing the same network stacks. Client 102 can communicate with the network node 440 via internet network 104a, while the network node 440 can communicate with the virtual server 470 via a leased network 104b. Client 102 can communicate using a client network stack 453 having an ICA protocol 450a as the presentation layer protocol over EDT 450e protocol, which is over a DTLS 450f protocol, which is over UDP 450g protocol. Once constructed or configured in accordance with the client network stack 453, network data from the client 102, destined to the virtual server 470, can be sent to the network node 440.

Network node 440 can receive the network traffic from the client 102 and can parse, unpackage or decapsulate the received network traffic. The network node 440 can monitor and track the network packets and store them in a local cache memory to be able to retransmit them in the event they are lost during the transmission. Network node 440 can parse, unpackage or decapsulate network traffic with respect to UDP 450g protocol, DTLS 450f protocol and EDT 450e protocol. Network node 440 can locally store in memory or a cache the monitored network packets. Network node 440 can perform framing of the network packets and repackage them in accordance with the EDT 450e protocol that is over DTLS 450f protocol and that is over UDP 450g protocol. Network node 440 can then forward the network traffic from the client to the virtual server 470. Virtual server 470 can receive the network traffic and send network traffic of its own (e.g., from virtual services 410) to the client 102, via network node 440. The network node 440 can follow the same process for the network traffic from the virtual server 470 as it did for the network traffic from the client 102 and allow for continuous communication of the client 102 and virtual server 470 via the network node 440.

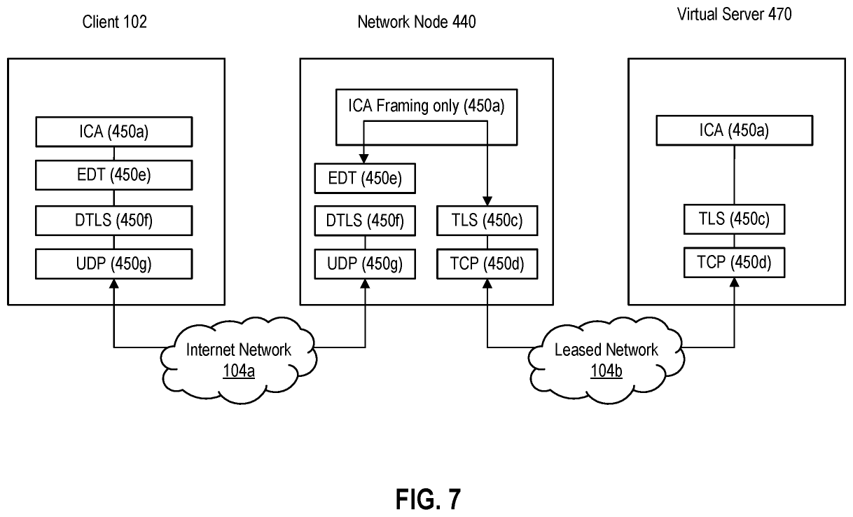

FIG. 7 includes an example of a communication process provided by a network node to a client 102 and a server 106 (e.g., virtual server 470), where the client uses UDP protocol and the server uses TCP protocol. As with the examples in FIGS. 5-6, a client 102 can communicate with the network node 440 via internet network 104a, while the network node 440 can communicate with the virtual server 470 via a leased network 104b. In this instance however, the client 102 can communicate using a client network stack 453 having an ICA protocol 450a as the presentation layer protocol, which is over EDT 450e protocol, which is over a DTLS 450f protocol and which is over UDP 450g protocol. Once constructed or configured in accordance with the client network stack 453, network data from the client 102, destined to the virtual server 470, can be sent to the network node 440.

When network node 440 receives the network traffic from the client 102, the network node 440 can parse, unpackage or decapsulate the network traffic from the client. The network node 440 can monitor and track the network packets and store them in a local cache memory to be able to retransmit them in the event they are lost during the transmission. Network node 440 can parse, unpackage or decapsulate network traffic with respect to UDP 450g protocol, DTLS 450f protocol and EDT 450e protocol. Network node 440 can locally store in memory or a cache the monitored network packets. Network node 440 can perform framing of the network packets and repackage them in accordance with the TLS 450c protocol over TCP 450d protocol. Network node 440 can then forward the network traffic from the client 102 to the virtual server 470. The virtual server 470 can receive the network traffic from the network node 440 and unpackage the network traffic in accordance with its network stack.

Virtual server 470 can then generate network traffic having a network stack of the virtual server 470. The network traffic of the virtual server 470 can include ICA protocol 450a as the presentation layer protocol over TLS 450c protocol that is over a TCP 450d protocol. Virtual server 470 can send the network traffic organized or structured in accordance with the virtual server 470 network stack 453. Network node 440 can receive the network traffic from the virtual server 470 can unpackage, decapsulate or parse the network packets in order to monitor or track the packets so as to be able to retransmit them in the future. The network packets can be locally stored in a cache. Network node 440 can package the network traffic from the virtual server 470 in accordance with the client network stack 453, including EDT 450e over DTLS 450f that is over UDPT 450g. Network node 440 can send the virtual server 470 network traffic over the UDP to the client 102. The client 102 can receive and read the network traffic based on the client 102 network stack of ICA protocol 450a as the presentation layer protocol over EDT 450e that is over DTLS 450f and that is over UDP 450g. The client can then send its own response and the whole process can be repeated, as needed.

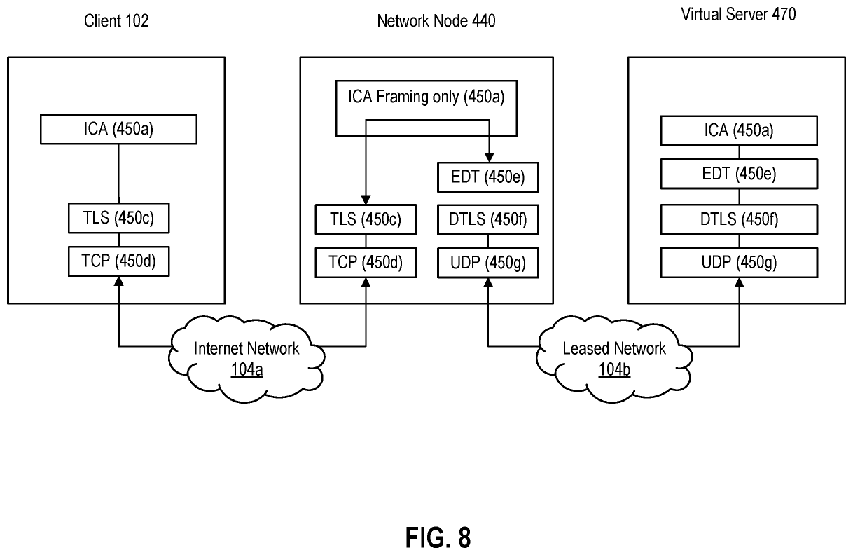

FIG. 8 includes an example of a communication process provided by a network node to a client 102 and a server 106 (e.g., virtual server 470), where the client uses TCP protocol and the server uses UDP protocol. As with the example in FIG. 7, a client 102 can communicate with the network node 440 via internet network 104a, while the network node 440 can communicate with the virtual server 470 via a leased network 104b. Client 102 can communicate using a client network stack 453 having ICA protocol 450a as the presentation layer protocol over TLS 450c, which is over TCP 450d. Once constructed or configured in accordance with the client network stack 453, network data from the client 102, destined to the virtual server 470, can be sent to the network node 440.

Once the network node 440 receives the network traffic from the client 102, the network node 440 can parse, unpackage or decapsulate the network traffic from the client, as well as monitor and track the network packets so as to be able to retransmit the network packets in the event they are lost. Network node 440 can parse, unpackage or decapsulate network traffic with respect to TCP 450d protocol and TLS 450c protocol. Network packets can be reframed in ICA 450a and rearranged or reconstructed in accordance with virtual server 470 network stack 453, which can include ICA 450a over EDT 450e that is over DTLS 450f and that is over UDP 450g. Network node 440 can then forward the network traffic from the client 102 to the virtual server 470. The virtual server 470 can receive the network traffic from the network node 440 and unpackage the network traffic in accordance with its network stack 453.

Virtual server 470 can then generate network traffic having a network stack of the virtual server 470, including ICA protocol 450a as the presentation layer protocol over EDT 450e protocol that is over DTLS 450f and that is over UDP 450g protocol. Virtual server 470 can send the network traffic to the network node 440 that can unpackage, decapsulate or parse the network packets in order to monitor or track the packets so as to be able to retransmit them in the future. The network packets can be locally stored in a cache. Network node 440 can package the network traffic from the virtual server 470 in accordance with the client network stack 453. Network node 440 can repackage or restructure network data to conform to the client 102 network stack 453 having ICA 450a over TLS 450c that is over TCP 450d. Network node 440 can send the virtual server 470 network traffic over the TPC to the client 102.

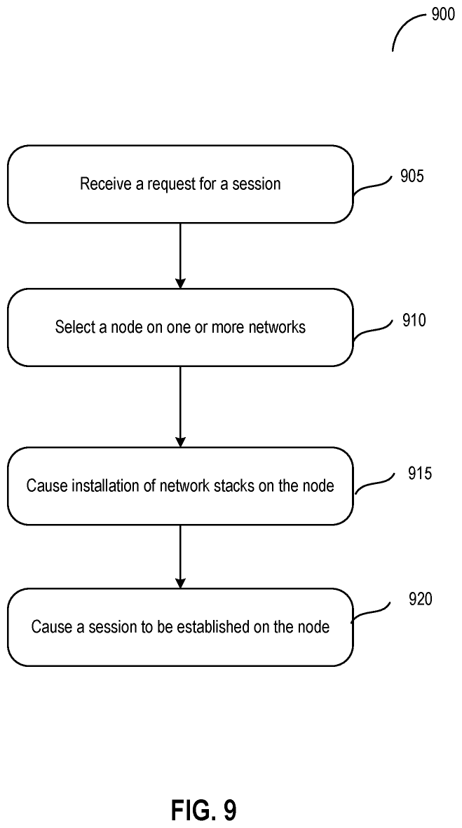

FIG. 9 illustrates a method 900 of establishing a session, on a third party network node configured to retransmit lost network data packets, between a client and a server communicating using different communication protocols. The method 900 can include acts 905-920. At act 905, an appliance receives a request for a session. At act 910, the appliance selects a node on one or more networks. At act 915, appliance can cause installation of network stacks on the node. At act 920, the appliance can cause a session to be established on the node.

At act 905, an appliance receives a request for a session. A device, such as an appliance or a server, can receive a request from a client device. The request can be a request to establish a session with one or more virtual servers. The request can be a request to establish a session with a physical server that can include or communicate with one or more virtual servers. The client device and the one or more virtual servers can communicate using at least a presentation services protocol over one or more lower-level protocols. The presentation services protocol can include a remoting protocol, such as ICA protocol or RDP protocol. The lower-level protocols can include a TCP or a UDP protocol.

The device can receive the request from an application on the client device, such as a workspace application executing on the client device. The request can be for the application of the client device to establish the session with the one or more virtual servers that include or provide at least one of a virtual desktop application or a virtual application. The device receiving the request can include one of a server hosting the one or more virtual servers or a gateway between the client device and the server.

At act 910, the appliance selects a node on one or more networks. The device, such as an appliance or a server can select one or more nodes from one or more networks to use for the session between the client device and the one or more virtual servers. The one or more nodes can be end points on a third party network, such as a CDN or an edge network. The device can select the one or more nodes based at least on one or more locations of the one or more nodes relative to one of the one or more virtual servers or the client device. The device can select the node based on the type of the network, such as a CDN rather than an edge network, or vice versa. The device can select the node based on the configuration of the node with respect to one or more protocols used by the virtual server or the client.

At act 915, appliance can cause installation of network stacks on the node. The device, such as an appliance or a server can cause an installation of one or more network stacks on the one or more nodes of a network of the one or more networks. The one or more network stacks can be configured to communicate with the client device and the one or more virtual servers. The one or more network stacks can be configured to communicate using at least the presentation services protocol over the one or more lower-level protocols. For example, a network stack can be configured to use independent computing architecture (ICA) protocol or remote desktop protocol (RDP) as presentation services protocols and UDP or TCP protocols as lower-level protocols. For example, the network stack can use any one or more of EDT protocol, TLS protocol or DTLS protocol. For example, the network stack can use Web Socket protocol and communications of client or virtual server can be based on the Web Socket configurations.

The installation can configure the node to handle retransmissions of packets between the client device, the one or more nodes, and the one or more virtual servers. The one or more network stacks can configure the node to handle retransmissions of packets of the client device to the one or more virtual servers on behalf of the client device. For example, the installation can configure a retransmission module to handle communication between a client device and a network node using one network stack, while the network node can handle communication between the virtual server and the network node using another network stack. The one or more network stacks can include a first network stack configured to communicate with the client device and a second network stack configured to communicate with the one or more virtual servers. The client device and the one or more nodes can select a lower-level protocol to communicate the presentation services protocol based at least on network conditions between the client device and the one or more nodes.

The one or more network stacks of the one or more nodes can be configured to communicate with the client device using a first lower-level protocol and to communicate with the one or more virtual servers using a second lower-level protocol different from the first lower-level protocol. For example, a network node can communicate with a client device using a UDP protocol, while communicating with a virtual server using a TCP protocol. The device can cause the one or more nodes to retransmit the packets between the workspace application and the at least one of the virtual desktop application or the virtual application, via the session.

At act 920, the appliance can cause a session to be established on the node. The device, such as the appliance or the server, can cause each of the client device and the one or more virtual servers to establish the session via the one or more nodes. The device can communicate a uniform resource identifier (URI) of the one or more nodes to each of the client device and the one or more virtual servers. The client device and the one or more virtual servers can connect to the one or more nodes using the URI. The device can communicate one or more security certificates of each of the client device and the one or more virtual servers to the one or more nodes to establish secure connections between the one or more nodes and each of the client device and the one or more virtual servers. The client device and the virtual server can use the URI and/or security certificates to establish connection or session with the one or more network nodes.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by a device, a request from a client device to establish a session with one or more virtual servers, the client device and the one or more virtual servers communicating using at least a presentation services protocol over one or more lower-level protocols;
selecting, by the device, one or more nodes from one or more networks to use for the session between the client device and the one or more virtual servers;
causing, by the device, an installation of one or more network stacks on the one or more nodes of a network of the one or more networks, the one or more network stacks being configured to communicate with the client device and the one or more virtual servers using at least the presentation services protocol over the one or more lower-level protocols and to handle retransmissions of packets between the client device, the one or more nodes, and the one or more virtual servers; and
causing, by the device, each of the client device and the one or more virtual servers to establish the session via the one or more nodes.

2. The method of claim 1, further comprising:
receiving, by the device, the request from a workspace application of the client device to establish the session with the one or more virtual servers comprising at least one of a virtual desktop application or a virtual application; and
causing, by the device, the one or more nodes to retransmit the packets between the workspace application and the at least one of the virtual desktop application or the virtual application, via the session.

3. The method of claim 1, further comprising selecting, by the device, the one or more nodes based at least on one or more locations of the one or more nodes relative to one of the one or more virtual servers or the client device.

4. The method of claim 1, wherein the presentation services protocol comprises a remoting protocol.

5. The method of claim 1, wherein the one or more network stacks comprises a first network stack configured to communicate with the client device and a second network stack configured to communicate with the one or more virtual servers.

6. The method of claim 1, wherein the device comprises one of a server hosting the one or more virtual servers or a gateway between the client device and the server.

7. The method of claim 1, further comprising communicating a uniform resource identifier (URI) of the one or more nodes to each of the client device and the one or more virtual servers, the client device and the one or more virtual servers connecting to the one or more nodes using the URI.

8. The method of claim 1, further comprising communicating one or more security certificates of each of the client device and the one or more virtual servers to the one or more nodes to establish secure connections between the one or more nodes and each of the client device and the one or more virtual servers.

9. The method of claim 1, wherein the client device and one or more nodes select a lower-level protocol to communicate the presentation services protocol based at least on network conditions between the client device and the one or more nodes.

10. The method of claim 1, wherein the one or more network stacks of the one or more nodes is configured to communicate with the client device using a first lower-level protocol and to communicate with the one or more virtual servers using a second lower-level protocol different from the first lower-level protocol.

11. A system comprising:
one or more processors coupled to memory and configured to:
receive a request from a client device to establish a session with one or more virtual servers, the client device and the one or more virtual servers communicating using at least a presentation services protocol over one or more lower-level protocols;
select one or more nodes from one or more networks to use for the session between the client device and the one or more virtual servers;
cause an installation of one or more network stacks on the one or more nodes of a network of the one or more networks, the one or more network stacks being configured to communicate with the client device and the one or more virtual servers using at least the presentation services protocol over the one or more lower-level protocols and to handle retransmissions of packets of the client device to the one or more virtual servers on behalf of the client device; and
cause each of the client device and the one or more virtual servers to establish the session via the one or more nodes.

12. The system of claim 11, wherein the one or more processors are configured to:
receive the request from a workspace application of the client device to establish the session with the one or more virtual servers comprising at least one of a virtual desktop application or a virtual application; and
cause the one or more nodes to retransmit the packets between the workspace application and the at least one of the virtual desktop application or the virtual application, via the session.

13. The system of claim 11, wherein the one or more processors select the one or more nodes based at least on one or more locations of the one or more nodes relative to one of the one or more virtual servers or the client device.

14. The system of claim 11, wherein the presentation services protocol comprises a remoting protocol.

15. The system of claim 11, wherein the one or more network stacks comprises a first network stack configured to communicate with the client device and a second network stack configured to communicate with the one or more virtual servers.

16. The system of claim 11, wherein the one or more processors comprises one of a server hosting the one or more virtual servers or a gateway between the client device and the server.

17. The system of claim 11, wherein the one or more processors communicate a uniform resource identifier (URI) of the one or more nodes to each of the client device and the one or more virtual servers, the client device and the one or more virtual servers connecting to the one or more nodes using the URI.

18. The system of claim 11, wherein the one or more processors communicates one or more security certificates of each of the client device and the one or more virtual servers to the one or more nodes to use to establish secure connections between the one or more nodes and each of the client device and the one or more virtual servers.

19. The system of claim 11, wherein the client device and one or more nodes select a lower-level protocol to communicate the presentation services protocol based at least on network conditions between the client device and the one or more nodes.

20. A non-transitory computer readable medium storing program instructions for causing at least one processor of a server to:
receive a request from a client device to establish a session with one or more virtual servers, the client device and the one or more virtual servers communicating using at least a presentation services protocol over one or more lower-level protocols;
select one or more nodes from one or more networks to use for the session between the client device and the one or more virtual servers;
cause an installation of one or more network stacks on the one or more nodes of a network of the one or more networks, the one or more network stacks being configured to communicate with the client device and the one or more virtual servers using at least the presentation services protocol over the one or more lower-level protocols and to handle retransmissions of packets of the client device to the one or more virtual servers on behalf of the client device; and
cause each of the client device and the one or more virtual servers to establish the session via the one or more nodes.
